(19) United States
(12) Patent Application Publication
(10) Pub. No.: US 2005/0230519 A1
(43) Pub. Date: Oct. 20, 2005

(54) Counter-quad tilt-wing aircraft design

(76) Inventor: Francis X. Hurley, Chapel Hill, NC (US)

Correspondence Address: Francis X. Hurley, 113 Charlesberry Lane, Chapel Hill, NC, 27517, US

(21) Appl. No.: 11/093,309

(22) Filed: Jun. 4, 2004

Related U.S. Application Data
(60) Provisional application No. 60/501,653, filed on Sep. 10, 2003.

(51) Int. Cl. B64C 27/22

(52) U.S. Cl. 244/7 C

(57) ABSTRACT

The invention consists of a specific, matched arrangement of aeronautical elements which (1) eliminates aerodynamic interference of, and (2) adds variable-cycle propulsion to, the level flight mode of a four-propulsor tilt-wing VTOL (vertical takeoff & landing) aircraft, without an additional element of variable geometry. This is achieved by configuring the components such that the rotor planes on either side pass through each other in the transition maneuver to form adjacent, close-coupled, counter-rotating pairs in level flight.

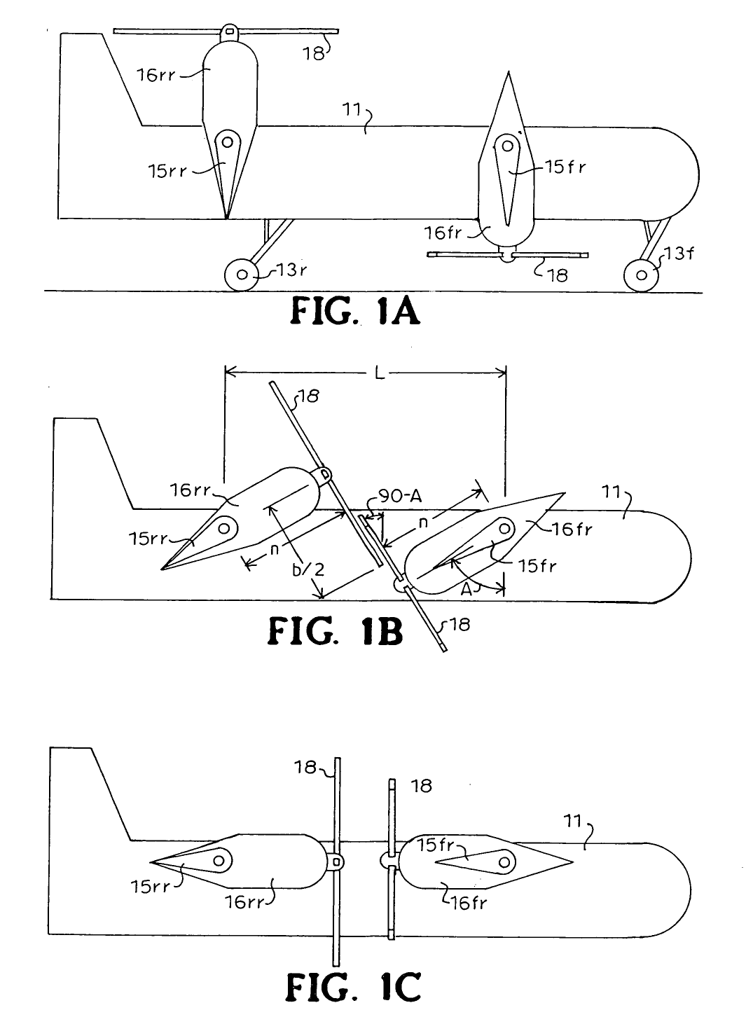

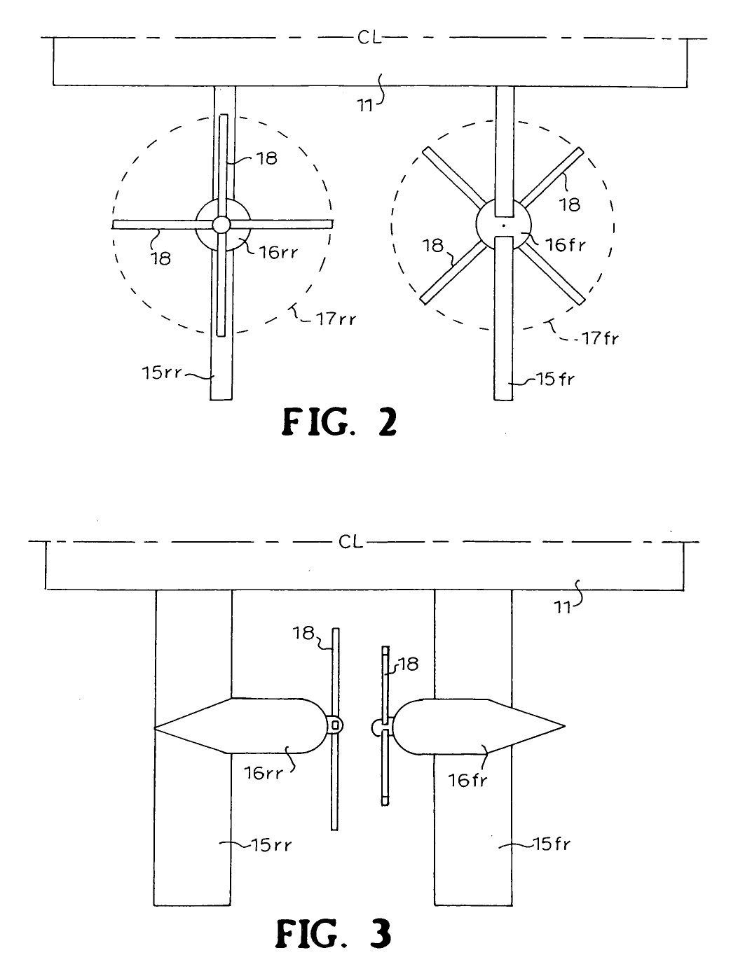

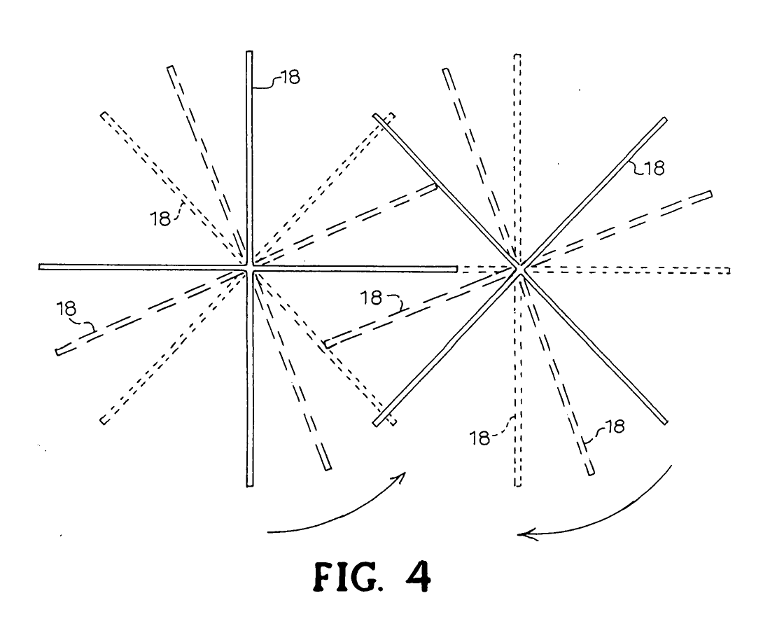

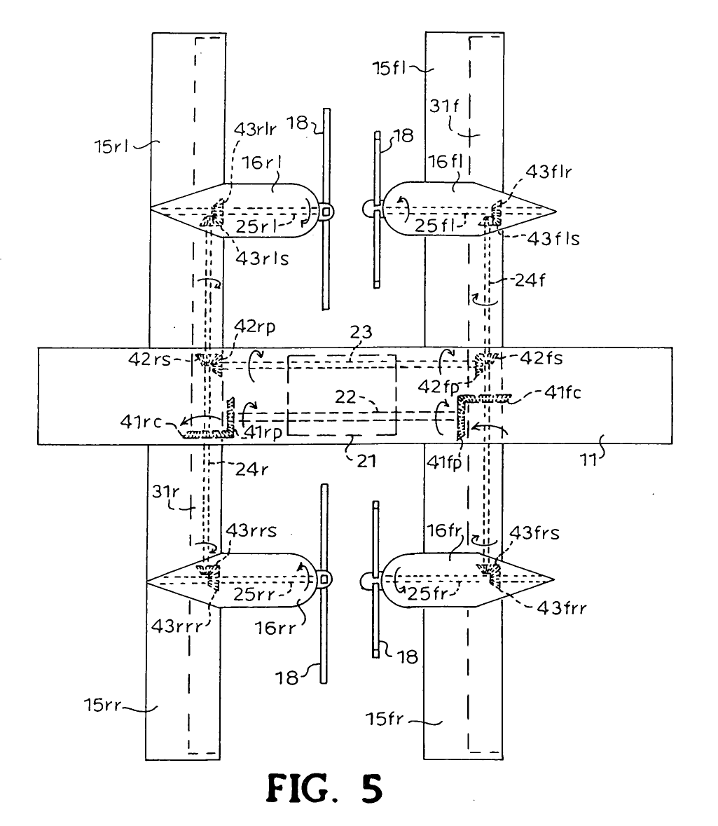

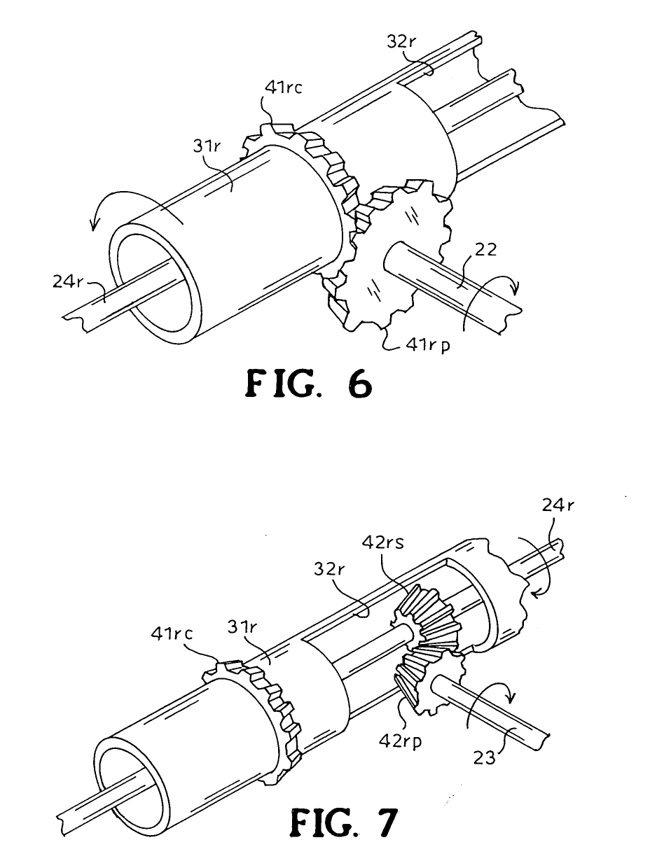

### BACKGROUND OF THE INVENTION

The design herein described exploits a proven repertory of separate technologies as surveyed below.

Both tilt-wing and tilt-rotor designs have been constructed and flown for many years. In each case, the propellers or rotors direct the air downward in the VTOL vertical flight mode and rearward in the level flight mode. Both concepts have their partisans, and both have advantages and disadvantages. In the present description, the tilt-wing has been preferred on the basis of its simpler, more predictable lifting surface/rotor wake aerodynamic interactions. Reference [1] provides an excellent 31-page summary of historical and contemporary tilt-wing aircraft of many companies.

Straightforward engineering enables meshed-rotor configurations wherein rotor planes overlap, in the fashion of a traditional egg-beater. Both shafts are driven off a single master gear, preserving a set angular displacement. Since any transmission failure normally terminates safe flight for even the simplest rotor system, there is little loss in reliability from adopting a meshed design. Kaman Corp has flight demonstrated meshed-rotors and has devised various applications, e g in reference [2].

Efficient vertical flight obtains through large-diameter rotors or “power discs” imparting small momentum increases to large volumes of air. However, large power discs develop extra drag and limit top speeds in the level flight regime. Means of affording variable-cycle aeropropulsion, i e operating on streamtubes of varied size, have been proposed e g in references [3] and [4]. These variable geometry schemes imply an extra degree of mechanical complexity.

Propellers are able to impart increased momentum to relatively small streamtubes through counter-rotating design. An outstanding example, as detailed in reference [5], was the Russian Tupolev Tu-95/142 “Bear” which with four counter-rotating turboprops developed top speeds very comparable to the American Boeing B-52 “StratoFortress” with eight turbofans. However it is a challenging engineering task to house the required, complex gearing within a single engine nacelle, and still provide ready access for maintenance and repair.

One VTOL tilt design concept that has attracted much attention in recent years is the quad-tilt configuration. Reference [6] provides a series of related articles. The “four-poster” stance lends robust stability, through cross-shafting, and it is not necessary to postulate four engines. One concern (which has led to extensive analysis and experimentation) is the issue of interference at the rear rotor from the wake of the fore rotor. Vortical, periodic flow at the rear power disc will tend to degrade its aeropropulsive efficiency and to instigate structural fatigue as well. Therefore configurations with spanwise and even vertical offsets between the power discs have been considered.

### BRIEF SUMMARY OF THE INVENTION

The arrangement described herein erases the above-mentioned interference problem in quad-tilt designs, through fluid mechanical analysis as follows.

Aerodynamic surfaces such as wings or rotor/propeller blades shed vorticity (produce a wake downwash) as the reaction to their developed lift. See e g reference [7]. After a number of chordlengths, in the “far wake,” the vorticity rolls up into a rather concentrated region of rotating air together with a core featuring accelerated streamwise flow. It is such developed wake structures, e g from all rotor blades, that jolt downstream airframe components. But the “near wake” of an aerodynamic surface is much more benign and smoothly-varying. In fact, the rearward component of a counter-rotating pair of propellers/rotors actually recovers the swirl energy that the forward component imparts. Reference [8] provides quantitative estimates of the (substantial) streamwise distances required for the onset of the offending roll-up phenomenon, and further confirms the aeropropulsive validity of counter-rotating designs like the Russian “Bear.”

Therefore the present invention consists of a quad-tilt configuration which positions the rear rotor close behind the fore rotor in level flight, with the properly opposing (counter) rotations. The resulting wake will be sensibly rotation-free, as well as halved in cross-section. Double the momentum addition per unit cross section of air will be imparted, amounting to variable-cycle aeropropulsion. Further, reduced wake turbulence hazards to trailing aircraft will result.

To achieve this close-coupling (without a major, further dimension of variable geometry such as wing fore-rear sliding), the mutually-geared rotors tilt from opposite directions and pass through each other in an egg-beater mesh fashion during the transition maneuver.

Two United States Patents contain related elements, though neither is a quad design concept. Reference [9] describes a conventional tilt-wing with a pair of counter-rotating prop-rotors instead of a pair of simple prop-rotors, discussing the aeropropulsive advantages of the former. Reference [10] describes a winged helicopter with tandem rotors mounted at the nose and tail of the fuselage. These rotors tilt analogously to those of the present invention, but do not form a close-coupled pair. Far from realizing the benefits of counter-rotation, the rear rotor will be battered by the fully-developed wake of the fore rotor.

### BRIEF DESCRIPTION OF THE DRAWINGS

FIGS. {1} through {7} provide a representation of the mechanical arrangement of the present invention. In particular, FIGS. {1A, 1B, 1C} trace the transition of the aircraft's geometry from a four-poster in hover to a twin-turboprop in level flight. FIGS. {5} through {7} present an internal layout of shafts and gears that can effect such geometrical transitions without unusual mechanical complexity. (Other layout designs are possible.)

### DETAILED DESCRIPTION OF THE INVENTION

Referring now to FIGS. {1A, 1B, 1C} featuring elevation views of the aircraft right side, it is seen that in the VTOL configuration (FIG. {1A}) the rear wing-propulsor unit is pointed upward while the fore wing-propulsor unit is pointed downward. In each case the air is directed downward which is to say the rear propulsor is a “tractor” rotor while the fore propulsor is a “pusher” rotor. In the transition maneuver, both units rotate clockwise, directing air progressively rearward. The rotor planes or power discs pass through each other (FIG. {1B}) without collision because of their opposite directions of rotation and under the assumptions that (1) they are geared together as mesh-rotors and (2) the rotor diameter b is not large enough to allow blade contact of opposite hubs during pass-through. Finally, the power discs are aligned and relatively adjacent, as counter-rotating propellers, in level flight (FIG. {1C}). The before-and-after plan views of the configuration's right half, to the centerline CL, are shown in FIGS. {2} and {3}.

Assumption (1) is illustrated in FIG. {4} showing the egg-beater meshing in forty-five degree rotational increments.

Assumption (2) requires the geometrical inequality (of vertical distance segments, viewing Figure {1B}):
2[nsin(90−A)]>(b/2)cos(90−A)
where b is the power disc diameter, n is the dimension of the nacelle forward of the wing pivot point, L is the horizontal distance between pivots, and A is the angle of nacelle tilt from the vertical so that (90−A)=arccos[n/(L/2)]. (The fore and rear nacelle-rotor sets are assumed to be identical.)

This reduces to:
(L/2)²>n²+(b/4)²
which defines the engineer's configuration design space for rotor diameter, nacelle length, and offset distance between the fore and aft wings. (The equality would describe the pythagorean theorem for the right triangle formed by the horizontal symmetry plane, the axis of the nacelle, and the blade half-length, in the hub-touch condition.) If b is too large, collisions as noted above can occur, and if n is too large, the power discs cannot “back out” through each other. (One degenerate case is that of the rotor diameter b very small, so that nacelle length n need only be less than half the offset distance L.)

In order to demonstrate the mechanical feasibility of the motions described above, FIGS. {5}, {6}, and {7} present a whole-aircraft shafts-and-gearing scheme that will provide the properly symmetrical and opposing rotations. Other implementation schemes are possible and do not constitute separate inventions. FIG. {5} is the complete configuration layout, showing separate, non-interfering wing tilt and rotor drive mechanical trains. Basically, each wing's carry-through structural element is a hollow cylinder which accepts tilt motion through a collar gear, while housing a spanwise rotor drive shaft, access to which is effected through a cutout. (A “natural” component numbering scheme has been used, i e fore and rear are designated by f and r, left and right are designated by l and r, prime is designated by p, cylinder is designated by c, spanwise is designated by s, and rotor is designated by r.) In this latter drawing, it is important to note that each prime power shaft is a single element and addresses the fore and rear components together and therefore without loss of synchronicity. Otherwise, the possibility of collisions between blades 18 would obtain as the front and rear rotors pass through each other's planes. (Also, detailed design would probably specify rotor shaft bearings at the front and back of each nacelle, wing-spanwise shaft bearings embedded at two or more locations within each cylinder, and sleeve bearings for the cylinders themselves at the fuselage take-out points.) Rotations are readily transferred between shafts orthogonal to one another through conical gears. FIG. {6} illustrates forty-five degree gear meshing between the wing tilt prime mover shaft (aligned with the fuselage 11) and the aforementioned cylinders. For the rear (fore) wing tilt, the prime mover shaft 22 employs its gear 41rp (41fp) to drive cylinder collar gear 41rc (41fc) and therefore cylinder 31r (31f) together with wings 15rl (15fl) and 15rr (15fr) and their nacelles 16rl (16fl) and 16rr (16fr). FIG. {7} illustrates forty-five degree gear meshing between the rotor drive prime mover shaft (aligned with the fuselage 11) and the aforementioned spanwise shafts. For the rear (fore) rotor drives, the prime mover shaft 23 enters cylinder 31r (31f) through cutout 32r (32f) and employs its gear 42rp (42fp) to drive spanwise shaft gear 42rs (42fs) and therefore shaft 24r (24f) which in turn employs its gears 43rls (43fls) and 43rrs (43frs) to drive rotor shaft gears 43rlr (43flr) and 43rrr (43frr) and therefore shafts 25rl (25fl) and 25rr (25fr) together with rotors 17rl (17fl) and 17rr (17fr).

One alternative to such a shafts-and-gears system would be electric drive. In this, a generator would be driven by the prime power plant and would send current to electric motors in the four nacelles. Electronic synchronization for collision-free rotor pass-through would be readily effected through rotation monitors or counters reporting to a central computer which in turn modulates the rotary motion.

It should be noted that the ground plane and landing gear 13f and 13r are depicted only in the FIG. {1A} elevation view because the wings tilt from the vertical orientation only when airborne. Also, the power plant 21 is purposely unspecified in that many options including hybrid arrangements are available.

To those skilled in the art, many modifications and variations of the present invention are possible in the light of the above teachings. For example, a tilt-rotor rather than tilt-wing version could employ the identical techniques. It is therefore to be understood that the present invention can be practiced otherwise than as specifically described herein and still will be within the spirit and scope of the appended claims.

The invention described herein may be manufactured, used, and licensed by the U S Government for governmental purposes without the payment of any royalties thereon.

1. A tilt-wing aircraft comprising
a fuselage with a contained power plant,
two tandem wing pairs capable of in-flight tilting between vertical and horizontal upon the fuselage, and
two nacelle-rotor pairs mounted rigidly upon the wings.

2. The aircraft of claim 1, wherein the configuration of elements and the scheme of tilt motion causes the front and rear rotors on either side to pass without collision through each other's planes in the transition maneuver from vertical to horizontal and then to operate as closely-coupled counter-rotating pairs in level flight.

3. The variable geometry of claim 2 wherein synchronized wing tilt is effected from a first shaft of the power plant, and synchronized rotor drive is effected from a second shaft of the power plant.

4. The mechanical scheme of claim 3 wherein the wings are tilted by means of conical collar gears on their carry-through-structure cylinders, and the shafts to the nacelle-rotor assemblies are contained in said cylinders and driven by means of conical gears through cutouts in said cylinders.

5. The aggregate design of claims 1, 2, 3, and 4, resulting in a quad or four-poster VTOL aircraft which operates on halved streamtubes or power discs in level flight, thus achieving variable-cycle propulsion.
